(19) United States
(12) Patent Application Publication
(10) Pub. No.: US 2008/0034347 A1
(43) Pub. Date: Feb. 7, 2008

(54) SYSTEM AND METHOD FOR SOFTWARE LIFECYCLE MANAGEMENT

(76) Inventors: Subramanyam V, Bangalore (IN); Sangeeta Kar, Bangalore (IN)

Correspondence Address: GLOBAL IP SERVICES, PLLC, 10 CRESTWOOD LANE, NASHUA, NH, 03062, US

(21) Appl. No.: 11/557,980

(22) Filed: Nov. 9, 2006

(30) Foreign Application Priority Data
Jul. 31, 2006 (IN) 1355/CHE/2006

(51) Int. Cl. G06F 9/44

(52) U.S. Cl. 717/101

(57) ABSTRACT

A computerized tool and techniques for enabling a software lifecycle management tool for an end user is provided. In one example embodiment, this is accomplished by using a V-process software development lifecycle model built with a workflow engine on an IT governance application. The technique provides an end-to-end life cycle with automatic review processes that complies with an external quality standard, such as level 2 CMMI. Further, the technique provides an on-line reference document including best practices at each phase in the V-process lifecycle.

This application claims priority under 35 USC [symbol] 119 (c) (1) of provisional application No. 1355/CHE/2006, Filed on Jul. 31, 2006.

### TECHNICAL FIELD OF THE INVENTION

The present invention relates to project management, and more particularly relates to an automated system for real-time management and monitoring regulatory compliance of projects for IT (information technology) industry.

### BACKGROUND OF THE INVENTION

In the current business environment, effective project management is a key factor in the success of many enterprises. Therefore, today's IT organizations have become increasingly concerned about effective project management. Accordingly, IT organizations typically strive to achieve effective project management by implementing a full life cycle project management solution, wherein each project in an IT organization's portfolio is created and developed according to a comprehensive lifecycle process.

In general, to be considered a comprehensive project life cycle management solution that would enable an IT organization to realize the above goals and to increase project success rate, a software lifecycle management tool must, at a minimum, enable to perform the following five functions. First, the software lifecycle management tool must enable the IT organizations to perform executive real-time monitoring and control of its projects. Second, the software lifecycle management tool must enable the IT organization to utilize current industry knowledge and best-practices in managing a project. Third, the software lifecycle management tool must enable the IT organizations to have a more detailed view or “drill-down” capability to identify problems as early as feasible in each project's lifecycle. Fourth, the software lifecycle management tool must enable the IT organizations to effectively balance the lifecycle process with creativity. Finally, the software lifecycle management tool must enable the IT organization to continually strive to reduce overall time to progress through the project lifecycle process.

Compliance with internal project management systems and policies is rarely sufficient to meet the demands of the marketplace. In today's business environment, compliance with external standards, quality assurance programs and protocols, must often be demonstrated to customers, potential customers and entities that create and certify compliance with the standards. In some cases compliance with multiple standards and protocols, such as ISO, CMMI, six-sigma, and so on must be demonstrated in connection with a single project.

There are a number of software lifecycle management tools well known in the art that may be used by an IT organization for project lifecycle management. Typically, these software lifecycle management tools do not provide real-time updates and user access to the most accurate information available at any time to facilitate real-time visibility and control over the IT operations. In addition, no single prior art solution provides an integrated workflow-enabled proven technique that enables an IT organization to deliver projects on-time, within budget and a desired quality.

### SUMMARY OF THE INVENTION

According to an aspect of the subject matter, there is provided an integrated lifecycle enabled IT governance system, that enables generation of at least one software program for an end user, including a project lifecycle management processor for prompting at least one participant to perform a plurality of tasks such that the at least one participant is guided through a lifecycle process for generating the at least one software program that enables a monitoring and overseeing function and a user interface for enabling a data processing system for the participant and for enabling the participant to input data to the lifecycle management processor and access data from the lifecycle management processor according to role-based, lifecycle model based, and/or activity based access.

### BRIEF DESCRIPTION OF THE DRAWINGS

Embodiments of the invention will now be described, by way of example only, with reference to the accompanying drawings in which:

FIG. 1 is a flowchart illustrating an example method of implementing a V-process lifecycle management tool according to an embodiment of the present subject matter.

FIG. 2 is a block diagram illustrating external standards to project management tool mapping according to an embodiment of the present subject matter.

FIG. 3 is a screenshot representation that illustrates project execution process using V-process software development lifecycle model according to an embodiment of the present subject matter.

FIG. 4 is a screenshot representation that illustrates capturing project planning phase of the V-process software development lifecycle model according to an embodiment of the present subject matter.

FIG. 5 is a screenshot representation that illustrates capturing requirements specification phase of the V-process software development lifecycle model according to an embodiment of the present subject matter.

FIG. 6 is a screenshot representation that illustrates capturing acceptance test plan creation phase of the V-process software development lifecycle model according to an embodiment of the present subject matter.

FIG. 7 is a screenshot representation that illustrates capturing functional specification phase of the V-process software development lifecycle model according to an embodiment of the present subject matter.

FIG. 8 is a screenshot representation that illustrates capturing system test planning phase of the V-process software development lifecycle model according to an embodiment of the present subject matter.

FIG. 9 is a screenshot representation that illustrates capturing design phase of the V-process software development lifecycle model according to an embodiment of the present subject matter.

FIG. 10 is a screenshot representation that illustrates capturing integration test planning phase of the V-process software development lifecycle model according to an embodiment of the present subject matter.

FIG. 11 is a screenshot representation that illustrates capturing program specification phase of the V-process software development lifecycle model according to an embodiment of the present subject matter.

FIG. 12 is a screenshot representation that illustrates capturing coding and unit testing phase of the V-process software development lifecycle model according to an embodiment of the present subject matter.

FIG. 13 is a screenshot representation that illustrates real-time project monitoring and management (i.e., a project manager's dashboard) according to an embodiment of the subject matter.

FIG. 14 is another screenshot representation that illustrates real-time project monitoring and management (i.e., a project manager's dashboard) according to an embodiment of the subject matter.

FIG. 15 is a block diagram of architecture for an integrated work-flow enabled IT governance system according to an embodiment of the present subject matter.

FIG. 16 is a block diagram of a typical computer system upon which an embodiment of the present subject matter, such as those shown in FIGS. 1-15, may operate.

### DETAILED DESCRIPTION OF THE INVENTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

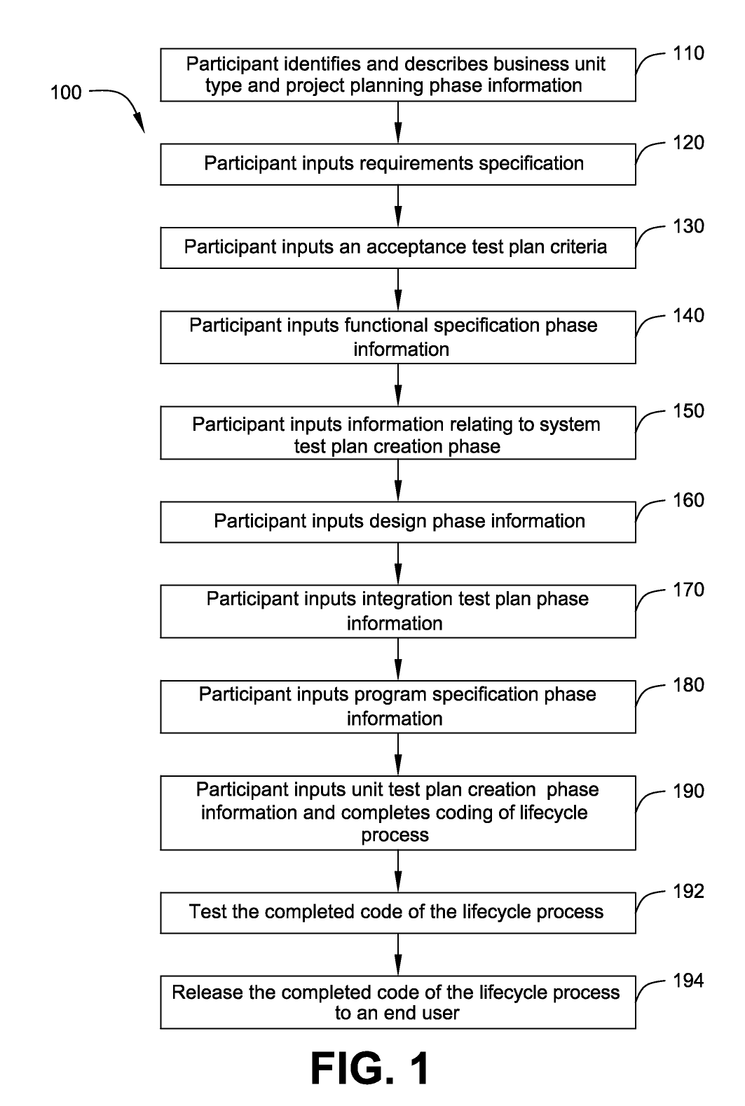

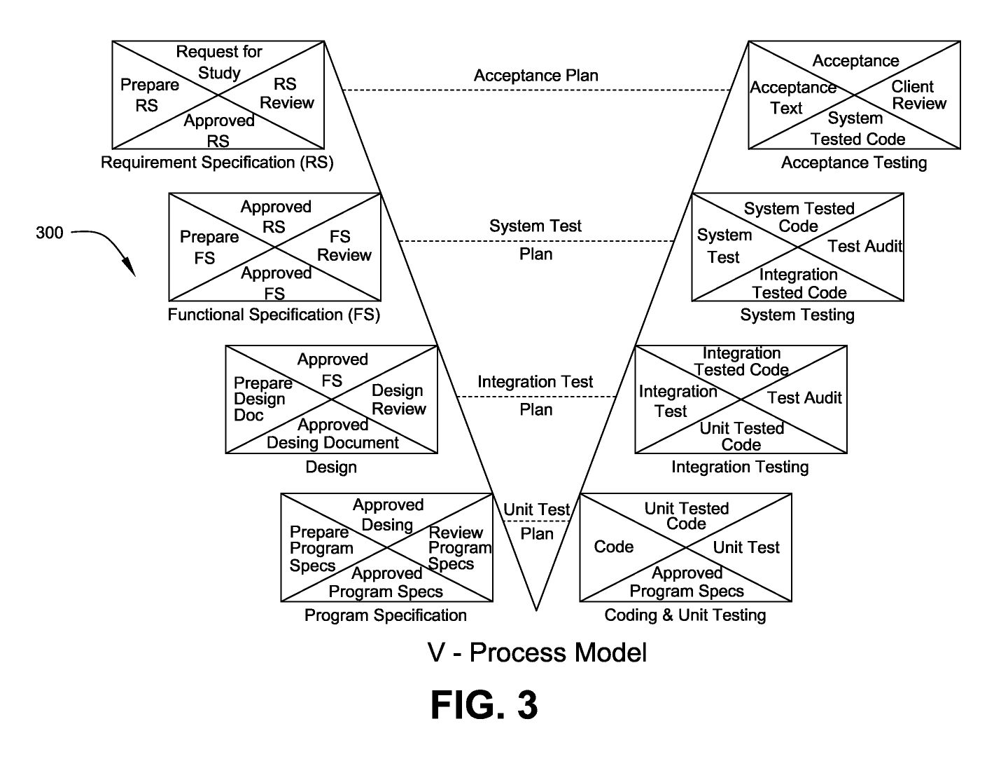

FIG. 1 illustrates an example method 100 for implementing a V-process lifecycle management tool that enables a software program for an end user. Referring now to FIG. 3, there is shown an example V-process software development lifecycle model 300 that is used in implementing the V-process lifecycle management tool that enables the software program for an end user. The V-process software development lifecycle model 300 shown in FIG. 3 incorporates best practices of different international standards, such as CMM/CMMI, Six Sigma, ISO and the like. Further, the V-Process software development lifecycle model 300 shown in FIG. 3 is flexible, modular and supports multiple lifecycle models. Furthermore, the V-Process software development lifecycle model 300 shows the major phases and their interconnectivity. Each phase in the V-process software development lifecycle model 300 requires inputting associated information to complete the coding of the lifecycle process. It can be seen in FIG. 3, the V-process software development lifecycle model 300 includes 4 major hierarchical plans (i.e., unit test plan, integration test plan, system test plan and acceptance test plan) that interconnect the 8 major phases in the lifecycle process.

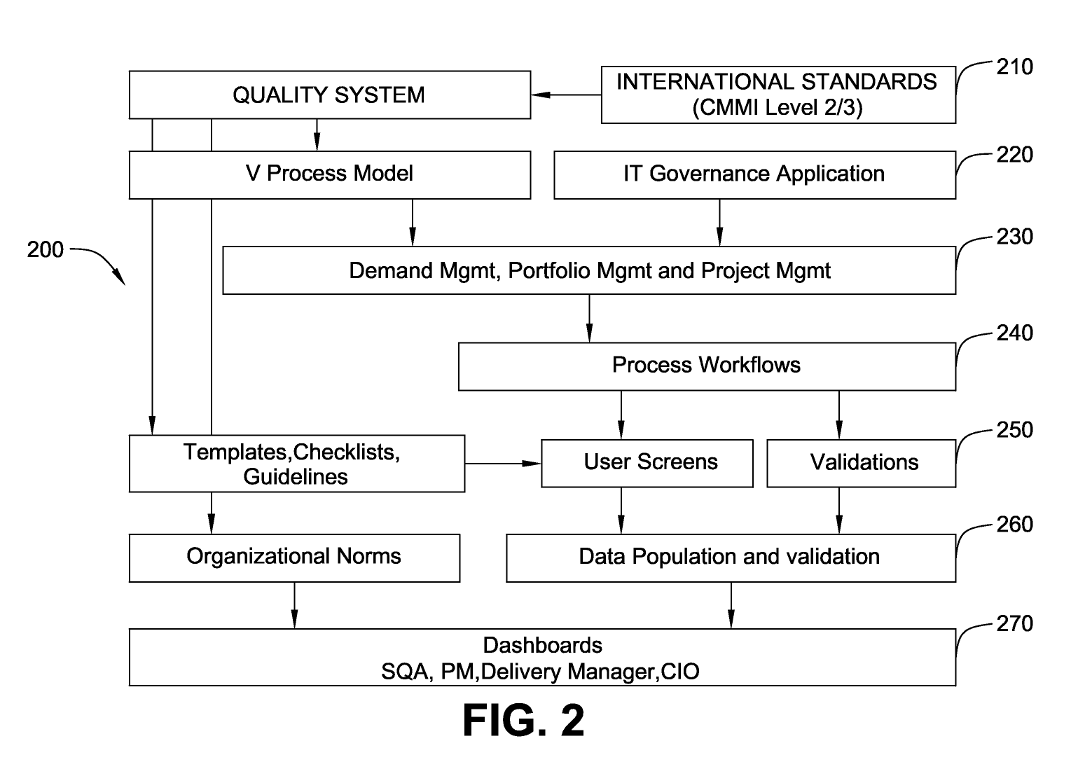

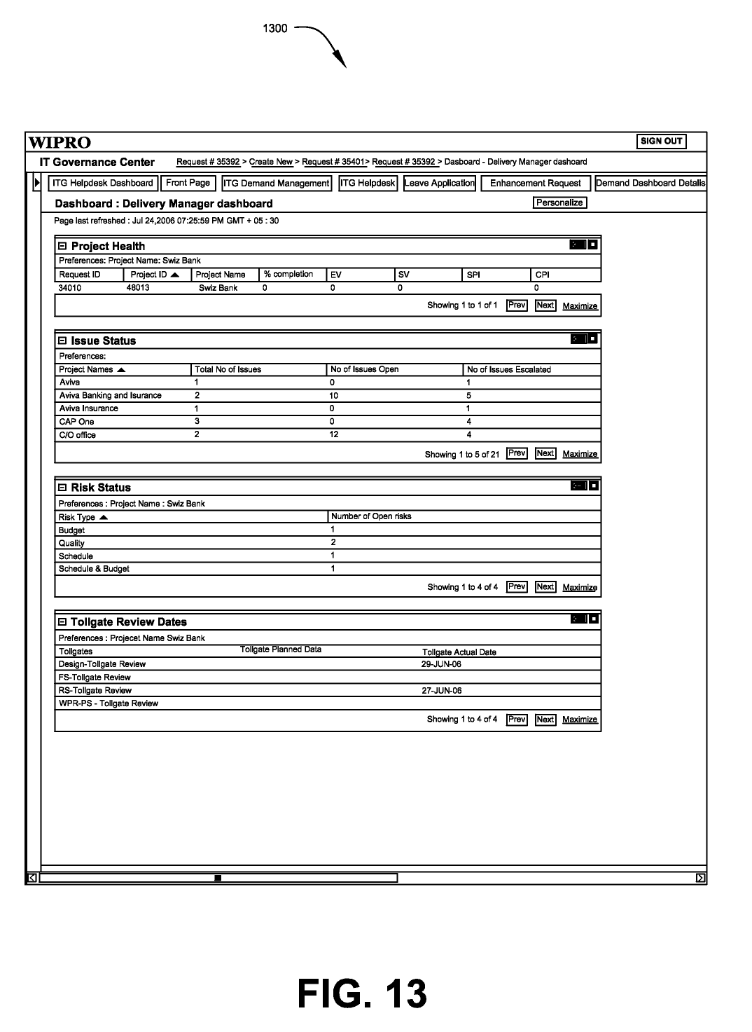

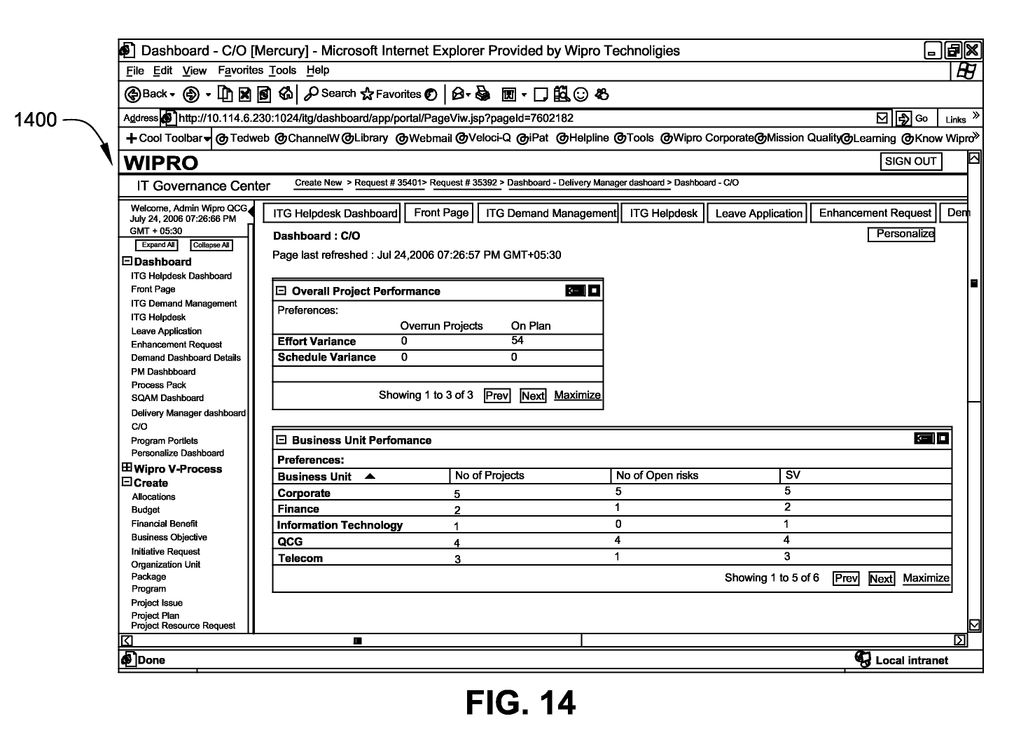

Referring now to FIG. 2, there is shown a block diagram 200 of quality system to IT governance system mapping that yields the V-process software development lifecycle model. The block diagram 200 includes multiple levels of inputting requirements and forming a monitoring tool, such as dashboards, SQA, PM, and the like at the end. The first level 210 is choosing a quality system for a specific external international standard, such as CMMI level 2/3. The second level 220 includes integrating the lifecycle process associated with the selected quality system and the chosen IT governance application. The third level 230 includes inputting demand management, such as request types and so on. The fourth level 240 includes converting V lifecycle process model into requirement document including workflow, request types, dashboards, security roles and so on. The fifth level 250 includes IT governance process pack technical design, such as roles specification, validations, workflow and sub workflow designs, identification of atomic processes, field definitions, and dashboard design. The fifth and sixth levels 250 and 260 can include configuration and unit testing, such as creation of workflow, sub workflows request types including all the fields and validations and roles and establishing relationships. The seventh level 270 includes creation of dashboard that includes creation of functions and procedures to query and display data to help facilitate real-time visibility and control over the IT operations. FIGS. 13 and 14 show example screenshots of dashboards that provide real-time visibility and control over the IT projects.

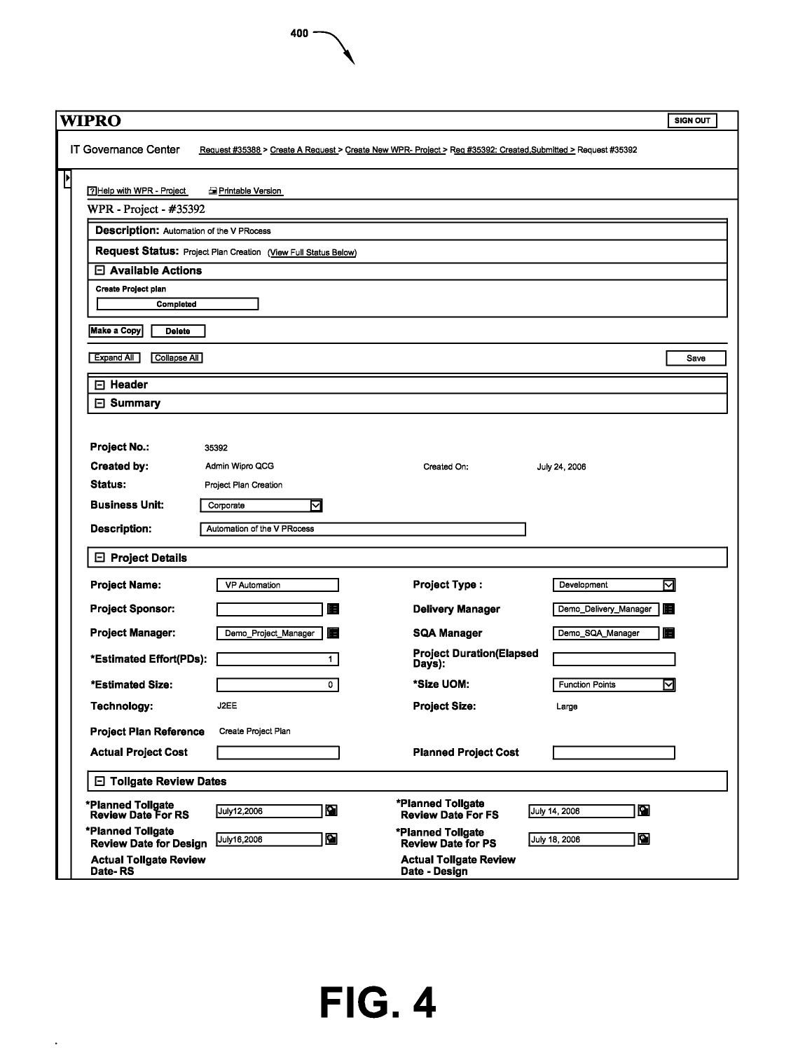

The method 100 shown in FIG. 1 begins at step 110 by a participant identifying, describing, and inputting business unit type and project planning phase information into a project lifecycle management processor. Upon successfully completing inputting the business unit type and project planning phase information the project lifecycle management processor enables the participant to proceed to a next phase in the lifecycle process. In some embodiments, the project lifecycle management processor determines whether the inputted business unit type and project planning phase information is satisfied based on first predetermined criteria and enables the participant to proceed to a next phase in the lifecycle process based on the outcome of the determination. Referring now to FIG. 4, there is shown an example screenshot of the user interface that facilitates in inputting the business unit type and project planning phase information for the project planning phase of the lifecycle process.

In these embodiments, the first act in the step 110 can require gathering type of the business unit and the project specific information. Further, the step 110 can require obtaining project name, project type, delivery manager's name, project manager information, SQA manager information, technology information, planned start date and end date of the project and so on. The next act in the step 110 in this process requires initiating the project and creating an overall project plan by using a standard template. The next step can require capturing the roles and assigning the specific roles to the resources associated with the project. Also, the step 110 can include defining the various phases and tasks of the lifecycle which will not be used or carried out during the entire lifecycle of the software development that is specific to this project. The step 110 can also include capturing units of measurement for the project. Furthermore, the step 110 may include getting the necessary approvals from the SQA managers and delivery managers and obtaining their review comments.

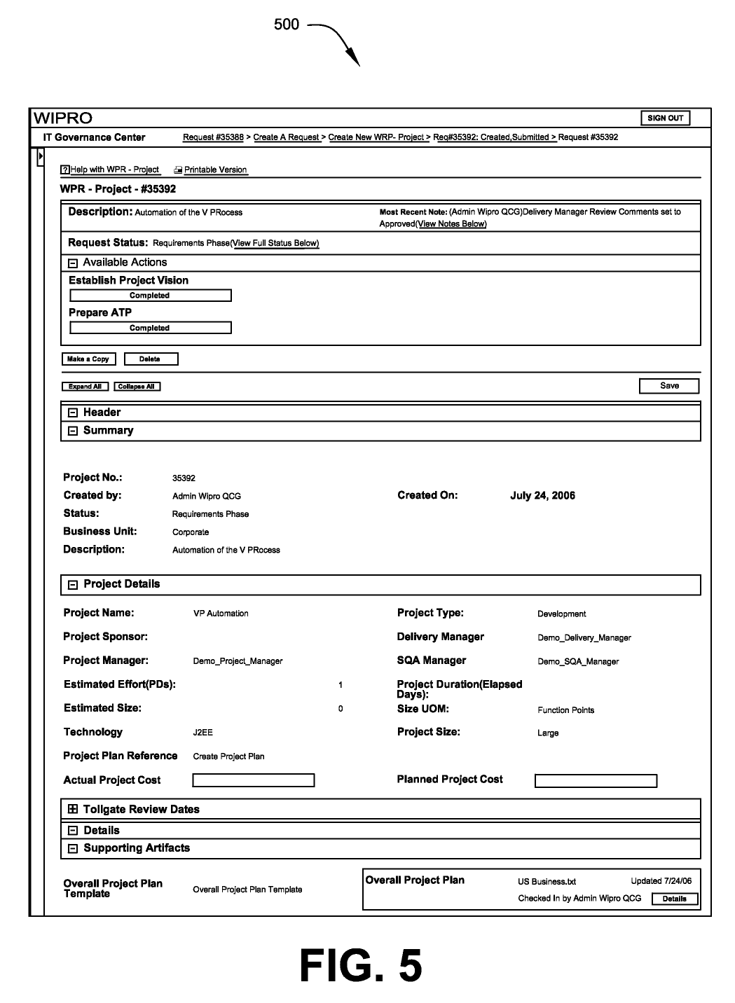

At step 120 the participant inputs requirements specification into the project lifecycle management processor. Upon successfully completing the inputting of the requirements specification the project lifecycle management processor enables the participant to proceed to a next phase in the lifecycle process. In some embodiments, the project lifecycle management processor determines whether the inputted requirements specification is satisfactory based on a second predetermined criteria and enables the participant to proceed to a next phase in the lifecycle process based on the outcome of the determination. Referring now to FIG. 5, there is shown an example screenshot of the user interface that facilitates in inputting the requirements specification.

In some embodiments, the step 120 can include eliciting requirements following the standard process and requirements engineering. Further, the step 120 can include creating a project vision, and requirements specification document. Furthermore, the step 120 may include analyzing non-technical, technical and testability requirements. Also, this step 120 can include reviewing requirements specification document and update the review checklist and update any defects that might be in the requirements specification.

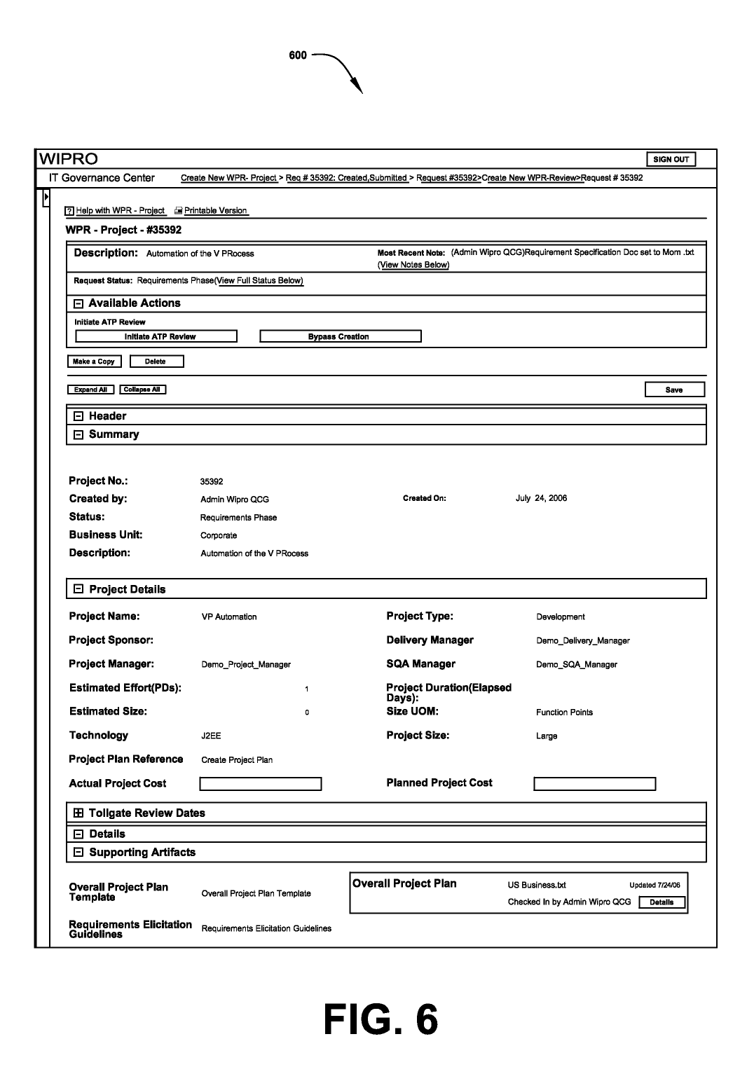

At step 130 the participant inputs acceptance test plan criteria into the project lifecycle management processor. Upon successfully completing the inputting of the acceptance test plan criteria the project lifecycle management processor enables the participant to proceed to a next phase in the lifecycle process. In some embodiments, the project lifecycle management processor determines whether the inputted acceptance test plan criteria is satisfactory based on a third predetermined criteria and enables the participant to proceed to a next phase in the lifecycle process based on the outcome of the determination. Referring now to FIG. 6, there is shown an example screenshot of the user interface that facilitates in inputting the acceptance test criteria into the project lifecycle management processor.

In some embodiments, the step 130 may carry out the requirements specification phase with the inputting of the acceptance test plan criteria. This step 130 can require preparing the acceptance plan associated with the finalized requirements specification. Further, the step 130 reviews the acceptance test plans in reference with the requirements and updates the review checklist. Upon substantially simultaneously completing the satisfactory inputting of the requirements specification and the acceptance test plan criteria, the step 130 requires reviewing the tollgate dates and gather actual tollgate dates for requirements specification phase. Upon successfully completing the inputting of the requirements specification and the acceptance test plan criteria the project lifecycle management processor enables the participant to proceed to a next phase in the lifecycle process.

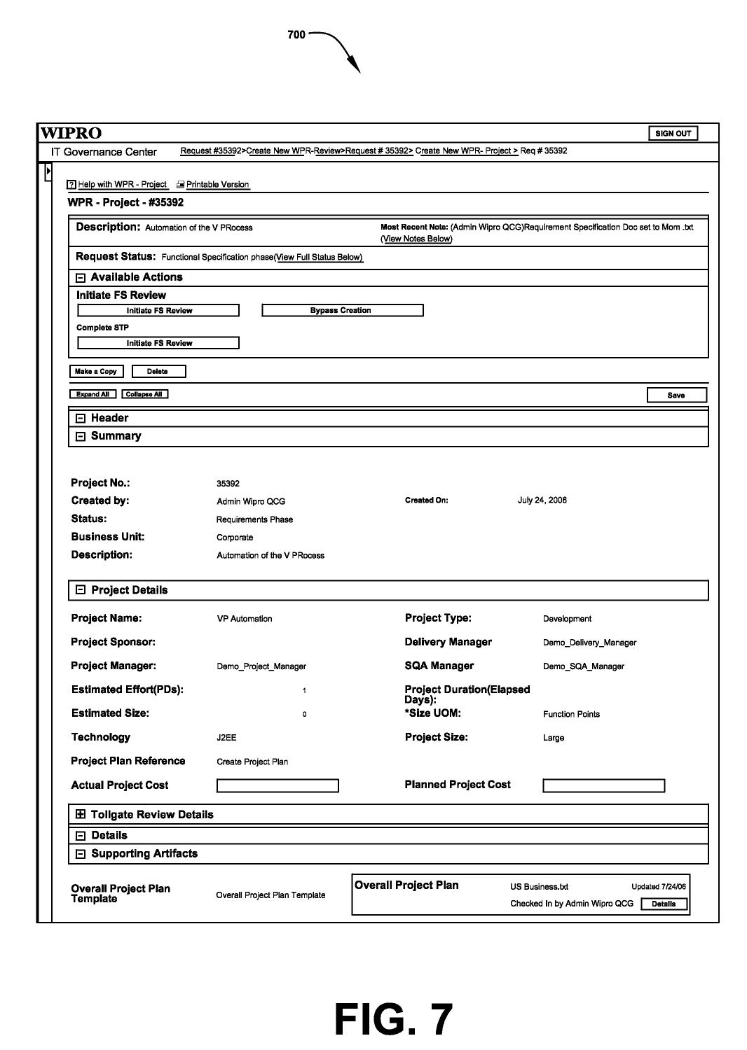

At step 140 the participant inputs functional specification phase information into the project lifecycle management processor. Upon successfully completing the inputting of the functional specification phase information the project lifecycle management processor enables the participant to proceed to a next phase in the lifecycle process. In some embodiments, the project lifecycle management processor determines whether the inputted functional specification phase information is satisfactory based on a fourth predetermined criteria and enables the participant to proceed to a next phase in the lifecycle process based on the outcome of the determination. Referring now to FIG. 7, there is shown an example screenshot of the user interface that facilitates in inputting the functional specification phase information into the project lifecycle management processor.

In some embodiments, the step 140 creates the functional specification document which is in reference with the requirements specification. Further, the step 140 may conduct a review of the document created and log the defects and efforts expended in completing creating the functional specification document.

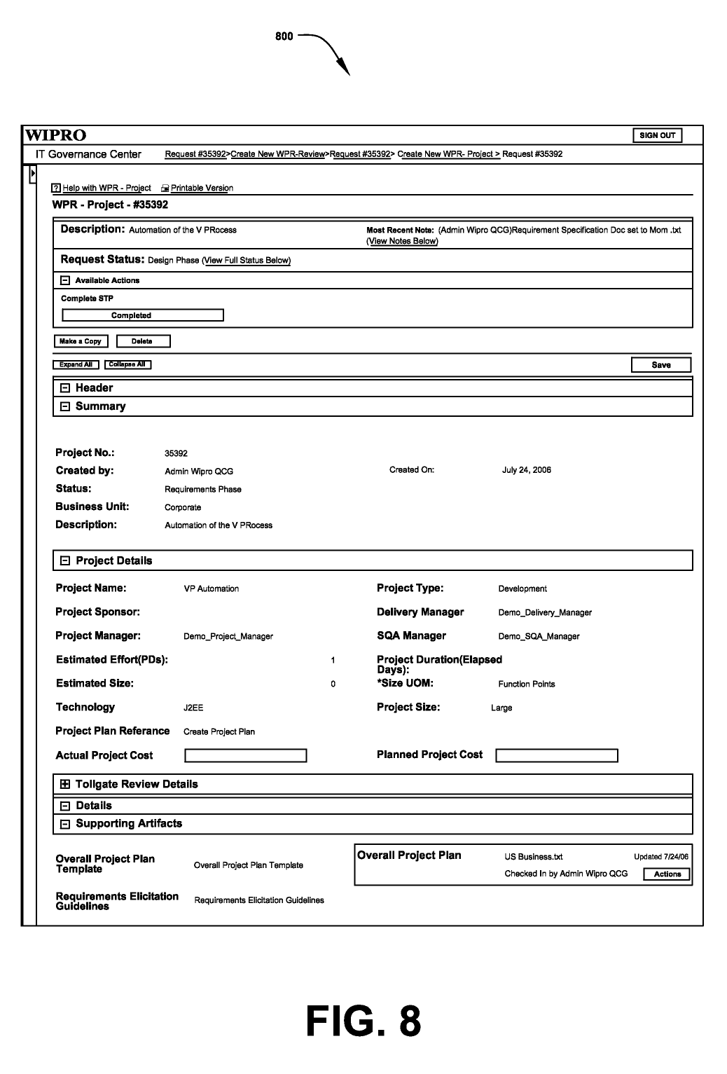

At step 150, the participant inputs system test plan creation phase information into the project lifecycle management processor. Upon successfully completing the inputting of the information relating to system test plan creation phase the project lifecycle management processor enables the participant to proceed to a next phase in the lifecycle process. In some embodiments, the project lifecycle management processor determines whether the inputted information relating to system test plan creation phase information is satisfactory based on a fifth predetermined criteria and enables the participant to proceed to a next phase in the lifecycle process based on the outcome of the determination. Referring now to FIG. 8, there is shown an example screenshot of the user interface that facilitates in inputting the system test plan creation phase information into the project lifecycle management processor.

In some embodiments, the step 150 may carry out the inputting of the functional specification information along with the inputting of the system test plan creation phase information. In this embodiment, the system test plan is created using the functional specification document and the requirements specification document. Further, the step 150 may require reviewing the system test plan by using a standard checklist before proceeding to the next phase of the lifecycle process. Review of requirements is carried out by an assigned group. Any defects is recorded and informed to any responsible person to fix the found defects and any efforts spent in fixing the defects are also recorded.

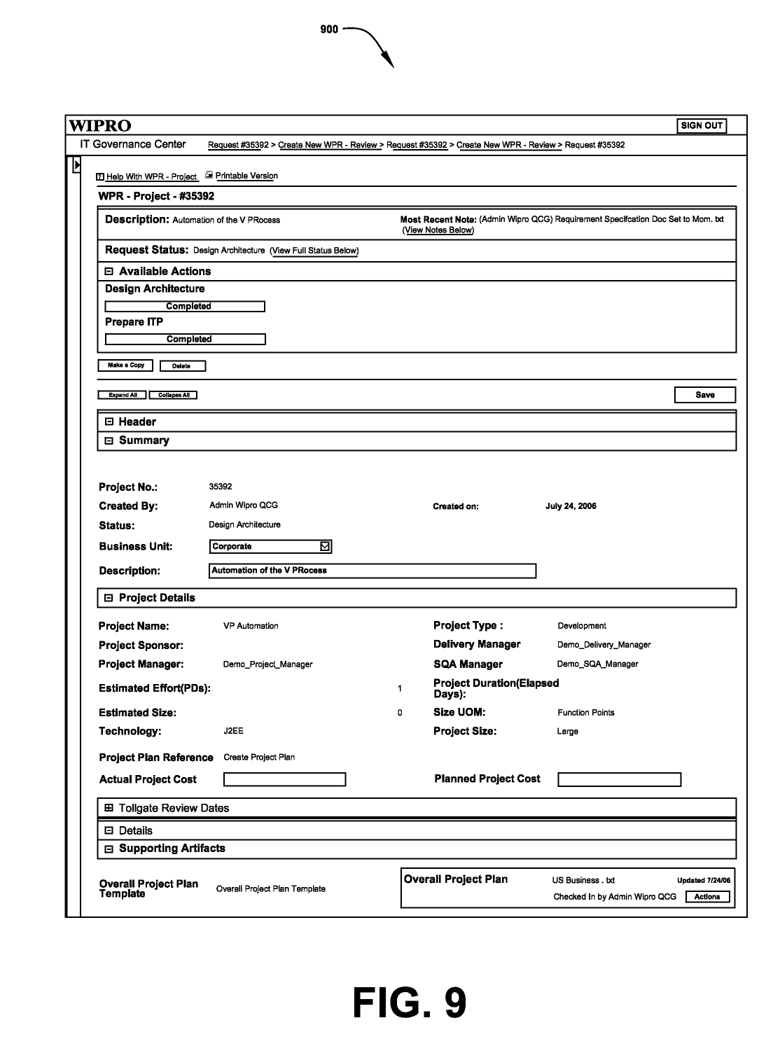

At step 160, the participant inputs design phase information into the project lifecycle management processor. Upon successfully completing the inputting of the design phase information into the project lifecycle management processor enables the participant to proceed to a next phase in the lifecycle process. In some embodiments, the project lifecycle management processor determines whether the inputted design phase information is satisfactory based on a sixth predetermined criteria and enables the participant to proceed to a next phase in the lifecycle process based on the outcome of the determination. Referring now to FIG. 9, there is shown an example screenshot of the user interface that facilitates in inputting the design phase information into the project lifecycle management processor.

In some embodiments, the step 160 requires creating design document, both high and low level documents. Also in this embodiment, the design architecture is tested for baseline functioning. This phase can also include preparing a detailed design document and base-lining the design.

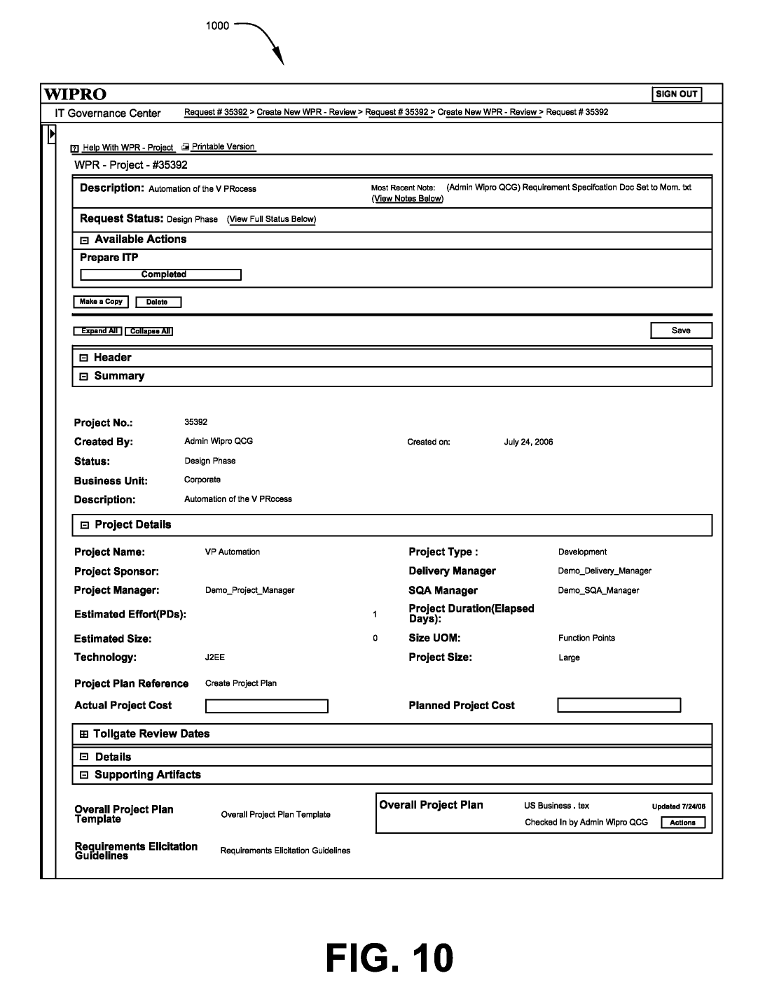

At step 170, the participant inputs integration test plan phase information into the project lifecycle management processor. Upon successfully completing the inputting of the integration test plan phase information into the project lifecycle management processor enables the participant to proceed to a next phase in the lifecycle process. In some embodiments, the project lifecycle management processor determines whether the inputted integration test plan phase information is satisfactory based on a seventh predetermined criteria and enables the participant to proceed to a next phase in the lifecycle process based on the outcome of the determination. Referring now to FIG. 10, there is shown an example screenshot of the user interface that facilitates in inputting the integration test plan phase information into the project lifecycle management processor.

In some embodiments, the step 170 may require step 160 to be carried out substantially parallely, i.e., inputting the information related to design phase and the integration test plan substantially parallely. In these embodiments, the step 170 requires creating an integration test plan. Further, the step 170 may require reviewing the integration test plan using a review check list and log any defects found during the review. Also, the step 170 may require capturing the tollgate review details of the integration test plan phase.

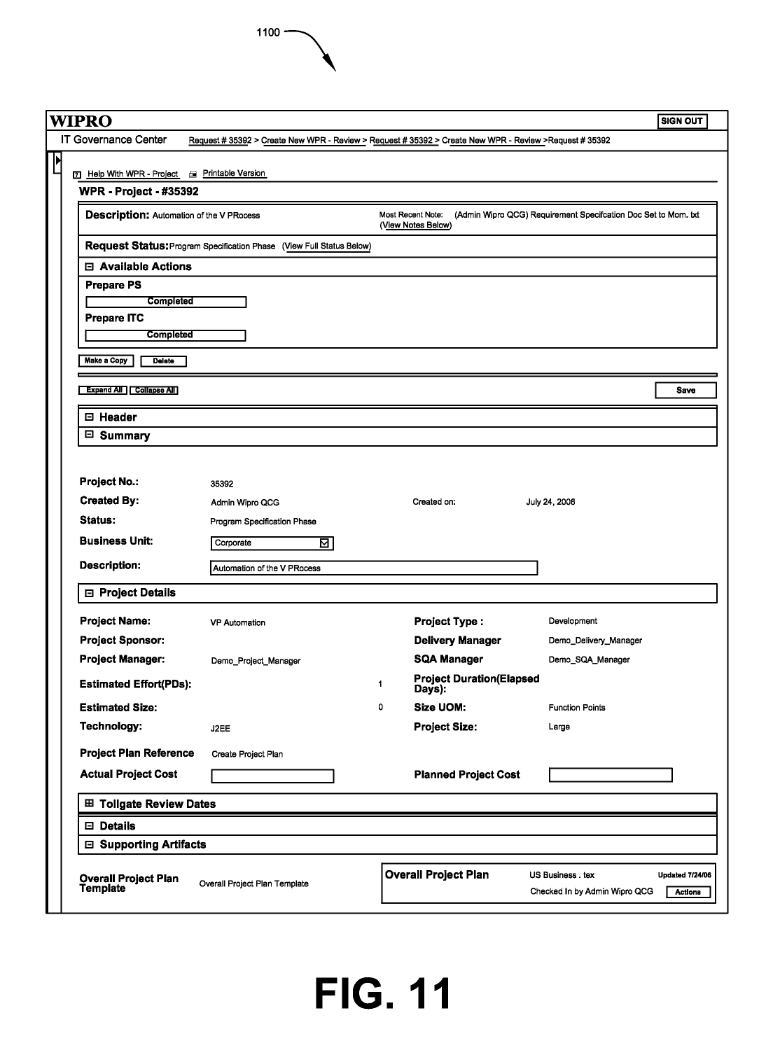

At step 180, the participant inputs program specification phase information into the project lifecycle management processor. Upon successfully completing the inputting of the program specification phase information into the project lifecycle management processor enables the participant to proceed to a next phase in the lifecycle process. In some embodiments, the project lifecycle management processor determines whether the inputted program specification phase information is satisfactory based on a eighth predetermined criteria and enables the participant to proceed to a next phase in the lifecycle process based on the outcome of the determination. Referring now to FIG. 11 there is shown an example screenshot of the user interface that facilitates in inputting the program specification phase information into the project lifecycle management processor.

In some embodiments, inputting of the information in step 180 is carried out substantially simultaneously with the inputting of the information associated with step 170. In these embodiments, the step 180 requires crating a program specification document. Further, the step 180 can require reviewing the created program specification document using a review checklist and log any found defects during the review.

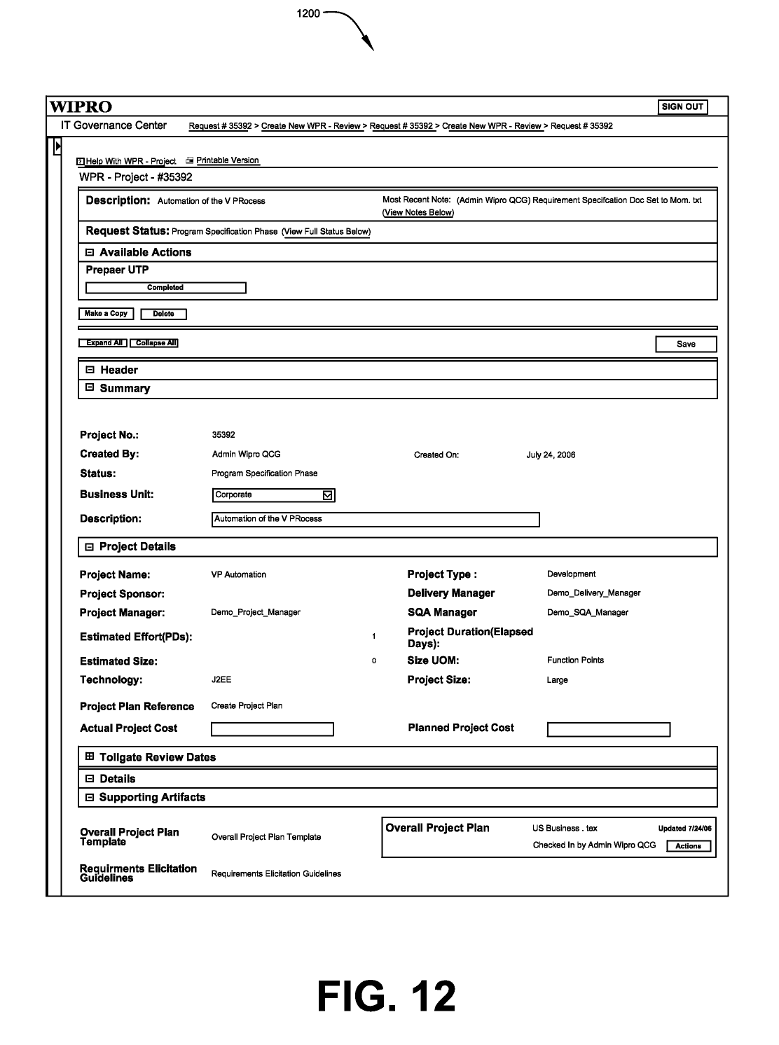

At step 190, the participant inputs unit test plan creation phase information into the project lifecycle management processor. Upon successfully completing the inputting of the unit test plan creation phase information into the project lifecycle management processor, coding of the lifecycle process is complete and the project lifecycle management processor enables to proceed to a next phase in the lifecycle process. In some embodiments, the project lifecycle management processor determines whether the inputted unit test plan creation phase information is satisfactory based on a ninth predetermined criteria and enables the participant to proceed to a next phase in the lifecycle process based on the outcome of the determination. Referring now to FIG. 12 there is shown an example screenshot of the user interface that facilitates in inputting the unit test plan creation phase information into the project lifecycle management processor.

In some embodiments, inputting of the information associated with the step 190 is carried out substantially in parallel with the inputting of the information associated with the step 180. In these embodiments, the step 190 requires preparing the unit test cases and the unit test plan. Also in these embodiments, the step 190 reviews the test cases and the test plan against a review checklist and logs any found defects during the review. Upon successful completion of the step 190, the project lifecycle management processor enables the participant to proceed to step 192. At step 192 the participant can test the completed code of the lifecycle process. At step 194, the participant can release the completed code of the lifecycle process to an end user upon successful completion of the testing of the completed code at step 192.

Although the flowchart 100 includes steps 110-194 that are arranged serially in the exemplary embodiments other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

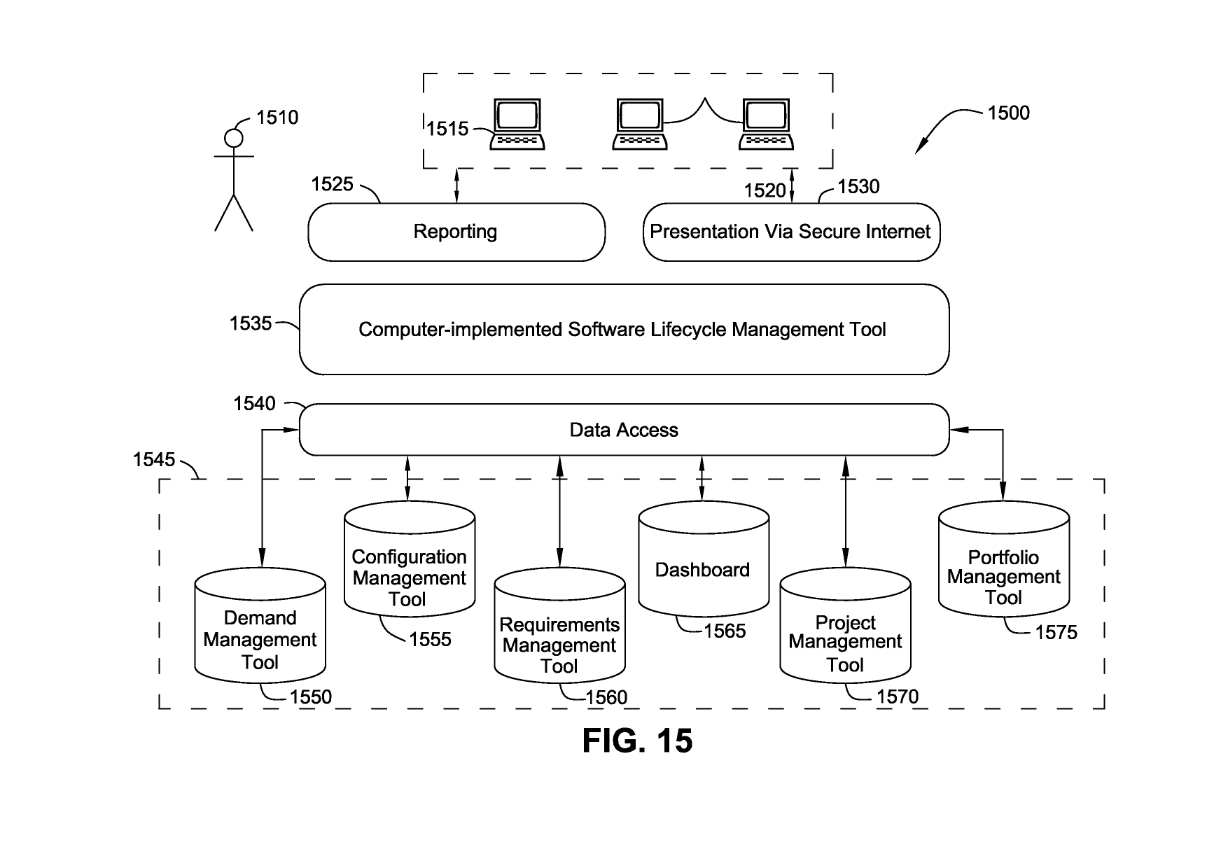

Referring now to FIG. 15, there is shown an example block diagram of an architecture for an integrated work-flow enabled IT governance system 1500. The integrated work-flow enabled IT governance system 1500 is used for managing a project comprising one or more programs and for generating each program for an end user and for enabling at least one stakeholder to monitor and oversee progress of a lifecycle process for the program generation. The integrated work-flow enabled IT governance system 1500 includes a lifecycle management processor (also referred to herein as a “computer-implemented software lifecycle management tool”) 1535 for prompting at least one participant to perform plurality of tasks such that the participant is guided through the lifecycle process for generating the software program and for enabling at least stakeholder to monitor and oversee the progress of the software program generation throughout the lifecycle process and the progress of the project.

A user of the integrated work-flow enabled IT governance system 1500 typically has, but not limited to, at least one of the following roles in an IT organization and also any software development process: Senior Management, Executives, Application managers, Channel managers, Developers, Finance managers, IT architects, Process managers, product managers, program managers, Quality Assurance (“QA”) managers, Reporting analysts, Requirements analysts, Strategists, and Technical managers or any other role as designated by the IT organization. The integrated work-flow enabled IT governance system 1500 is not limited to use by users in IT organization, but can also be used in any software development process. An end user 1510 is any individual, or any entity that will use the program once it is released, and may include customers and clients of the IT organization.

The integrated work-flow enabled IT governance system 1500 also includes a user interface 1515 for enabling the participant and the stakeholder to input data in response to at least one request for data from the lifecycle management processor 1535 as the lifecycle management processor guides the participant thought the life-cycle process. The user interface 1515 is alternatively enabled through the user of a browser-based such that URL pages enable thin client access to users of the integrated work-flow enabled IT governance system 1500 via a secured system 1530 that is networked in some conventional way, such as via Internet or an extranet networking system.

The software tools 1545 include demand management tool 1550, configuration management tool 1555, requirements management tool 1560, dashboard 1565, project management tool 1570, and portfolio management tool 1575. Further, the integrated work-flow enabled IT governance system 1500 includes data access 1540.

The integrated work-flow enabled IT governance system 1500 enables users to have role-based access to predefined views of the status of the program generation. The program lifecycle management processor 1535 enables a role-based predetermined view of status of the project and the program generation for each participant 1510 and the stakeholder. The integrated work-flow enabled IT governance system 1500 includes at least one data storage unit 1540 for storing and providing subsequent access to the data input by the participant and the stakeholder via the user interface 1515, for each program in the IT organization's program portfolio. The reporting 1525 can be via the dashboard 1565 to facilitate real-time monitoring and control over the IT projects.

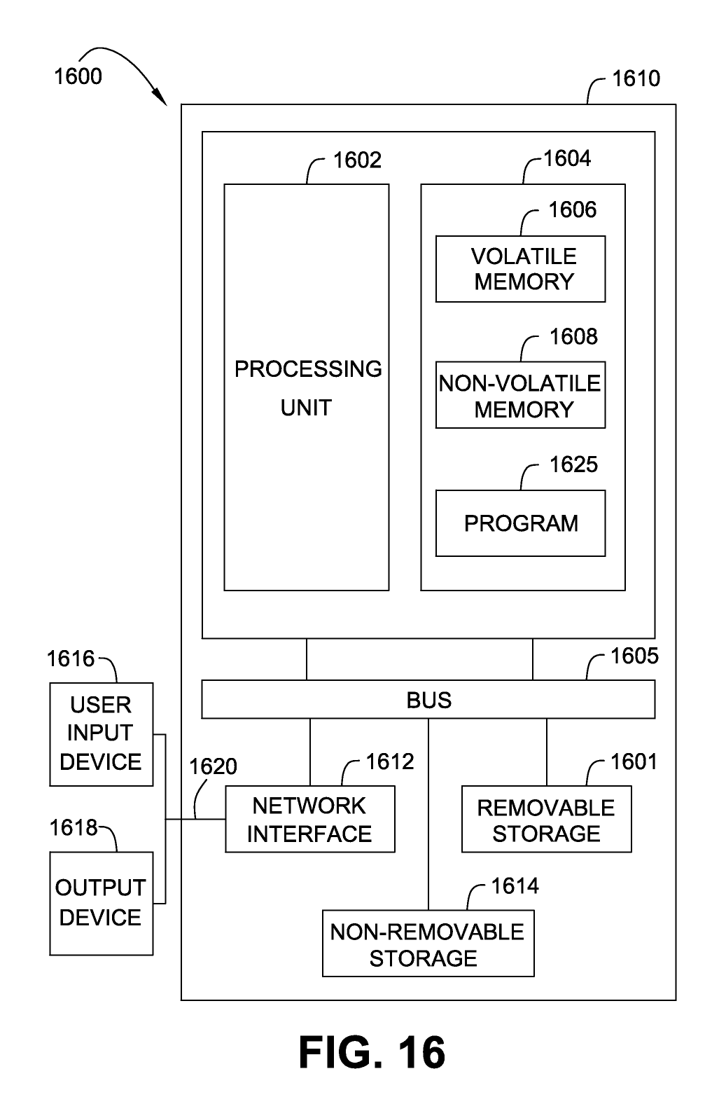

Various embodiments of the present subject matter can be implemented in software, which may be run in the environment shown in FIG. 16 (to be described below) or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 16 shows an example of a suitable computing system environment for implementing embodiments of the present subject matter. FIG. 16 and the following discussion are intended to provide a brief, general description of a suitable computing environment in which certain embodiments of the inventive concepts contained herein may be implemented.

A general computing device, in the form of a computer 1610, may include a processor 1602, memory 1604, removable storage 1601, and non-removable storage 1614. Computer 1610 additionally includes a bus 1605 and a network interface 1612.

Computer 1610 may include or have access to a computing environment that includes one or more user input modules 1616, one or more output modules 1618, and one or more communication connections 1620 such as a network interface card or a USB connection. The one or more output devices 1618 can be a display device of computer, computer monitor, TV screen, plasma display, LCD display, display on a digitizer, display on an electronic tablet, and the like. The computer 1610 may operate in a networked environment using the communication connection 1620 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 1604 may include volatile memory 1606 and non-volatile memory 1608. A variety of computer-readable media may be stored in and accessed from the memory elements of computer 1610, such as volatile memory 1606 and non-volatile memory 1608, removable storage 1601 and non-removable storage 1614. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 1602 of the computer 1610. For example, a program module 1625 may include machine-readable instructions capable of providing a real-time software lifecycle management tool according to the teachings and herein described embodiments of the present subject matter. In one embodiment, the program module 1625 may be included on a CD-ROM and loaded from the CD-ROM to a hard drive in non-volatile memory 1608. The machine-readable instructions cause the computer 1610 to encode according to the various embodiments of the present subject matter.

The operation of the computer system 1600 for recompiling executable code to improve performance is explained in more detail with reference to FIG. 1.

The above technique makes available specific project templates for detailed planning. The above process supports and makes available artifacts like templates, guidelines and checklists to project teams at every phase of the project. The review process and test defect tracking is integrated into the execution process. Further, the above process supports risk management, issue management and change control processes during project execution. Furthermore, the above process enables tailoring of the software development lifecycle model projects to pick and choose applicable phases and activities in each phase depending on the project requirements. Moreover, the above computerized tool provides dashboards for IT executive management with phase wise progress details, review, rework effort and defect metrics. The above process incorporates best practices of different external standards, such as CMM/CMMI, six-sigma, ISO 9000, and the like. The above technique yields CMMI level 3 compliance. Also, the above process is flexible, modular and supports multiple software development lifecycle models.

The above process combines off-the-shelf IT governance software with the rich experience of software process management to provide a real-time project management and monitoring tool that is easy to implement. The above technique is highly adaptable to suit organization specific needs while complying with standard methodologies. The above process can be incrementally plugged with minimum impact on existing operations.

Although, the above example embodiments shown in FIGS. 1-16 are explained with reference to a V-process based software development lifecycle model, the above-described technique is not limited to only V-process based software development lifecycle model, but it can be applicable any software development lifecycle model. Further, although the embodiments of the present invention are described in the context of non-distributed environment they can be very much implemented in the distributed environment as well.

The above technique can be implemented using an apparatus controlled by a processor where the processor is provided with instructions in the form of a computer program constituting an aspect of the above technique. Such a computer program may be stored in storage medium as computer readable instructions so that the storage medium constitutes a further aspect of the present subject matter.

The above description is intended to be illustrative, and not restrictive. Many other embodiments will be apparent to those skilled in the art. The scope of the subject matter should therefore be determined by the appended claims, along with the full scope of equivalents to which such claims are entitled.

As shown herein, the present subject matter can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the method illustrated in FIG. 1 can be performed in a different order from those shown and described herein.

FIGS. 1-16 are merely representational and are not drawn to scale. Certain proportions thereof may be exaggerated, while others may be minimized. FIGS. 1-16 illustrate various embodiments of the subject matter that can be understood and appropriately carried out by those of ordinary skill in the art.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive invention lies in less than all features of a single disclosed embodiment. Thus the following claims are hereby incorporated into the detailed description of the embodiments of the invention, with each claim standing on its own as a separate preferred embodiment.

1. A method for a computer-implemented software lifecycle management tool using an IT governance software, which project is defined by a series of lifecycle phases, wherein each lifecycle phase of the project is evaluated by one or more predetermined external standards, wherein each of the external standards defines a set of quality assurance steps in-order to achieve compliance with the external standard for each phase, comprising:
converting a software development lifecycle process into a requirements document based on business needs for IT governance software;
formulating technical design of the software development lifecycle process;
configuring the software lifecycle management tool using the requirements document and formulated technical design;
creating functions and procedures to query and display data in a dashboard; and
performing technical reviews by external standards practitioners and field force review personnel.

2. The method of claim 1, wherein the requirements document comprises documents selected from the group consisting of workflow, request types, dashboards, and security roles.

3. The method of claim 1, wherein formulating technical design comprises:
defining design parameters selected from the group consisting of roles specification, validations, workflow and sub-work flow designs, identification of atomic processes, field definitions, and dashboard design.

4. The method of claim 1, wherein configuring the software lifecycle management tool comprises:
creating of workflows, sub-workflows, request types including all the fields and validations, and establishing relationships.

5. The method of claim 1, wherein external standards comprises international quality standards selected from the group consisting of CMM, CMMI, ISO, and six-sigma.

6. A method for a computer-implemented software lifecycle management tool using an IT governance software, which project is defined by a series of software lifecycle phases, wherein each software development lifecycle phase of the project is evaluated by one or more predetermined external standards, wherein each of the external standards defines a set of quality assurance steps in-order to achieve compliance with the external standard for each phase, comprising:
selecting one of the software development lifecycle phases on a software development lifecycle model user interface;
displaying a screen associated with the selected one of the software development lifecycle phases and capturing information associated with the selected one of the software development lifecycle phases;
inputting the captured information associated with the selected one of the software development lifecycle phases; and
saving the captured information associated with the selected one of the software development lifecycle phases.

7. The method of claim 6, further comprising:
determining whether the selection of all of the software development lifecycle phases is completed;
if so, performing technical reviews by external standards practitioners and field force review personnel;
tailoring the software development lifecycle model by picking and choosing applicable phases and activities in each software development lifecycle software development lifecycle software development lifecycle software development lifecycle software development lifecycle phase based on the project requirements; and
reviewing executives' dashboard.

8. The method of claim 7, further comprising:
if not, repeating selecting, displaying inputting and saving for a next selected one of the software development lifecycle phases.

9. An integrated work-flow enabled IT governance system that includes generation of at least one software program for an end user comprising:
a project lifecycle management processor for prompting at least one participant to perform a plurality of tasks such that the at least one participant is guided through a lifecycle process for generating the at least one software program that enables a monitoring and overseeing function; and
a user interface for enabling a data processing system for the participant and for enabling the participant to input data to the lifecycle management processor and access data from the lifecycle management processor according to role-based, lifecycle model based, and/or activity based access.

10. The integrated work-flow enabled IT governance system of claim 9, wherein lifecycle process comprises the steps of:
prompting the participant to identify and describe business unit type and project planning phase information, wherein the project lifecycle management processor enabling the participant to proceed to the next phase in the lifecycle process when the identification and description of business unit type and project planning phase information is satisfied based on a first predetermined criteria;
prompting the participant to input requirements specification, wherein the project lifecycle management processor enables to evaluate the requirements specification and to proceed to the next phase in the lifecycle process when the inputted requirements specification is satisfied based on a second predetermined criteria;
prompting the participant input an acceptance test plan criteria, wherein the project lifecycle management processor enables to proceed to the next phase upon confirming the inputted requirements specification and the acceptance test plan criteria are completed satisfactorily based on a third predetermined criteria;
prompting the participant input functional specification phase information, wherein the project lifecycle management processor enables to proceed to the next phase upon confirming the inputted functional specification phase information and completed satisfactorily based on a fourth predetermined criteria;
prompting the participant to input information relating to system test plan creation phase, wherein the project lifecycle management processor enables to evaluate the inputted information relating to the system test plan creation phase and to proceed to the next phase in the lifecycle process when the inputted information relating to the system test plan creation phase is satisfied based on a fifth predetermined criteria;
prompting the participant to input design phase information, wherein the project lifecycle management processor enables to evaluate the design phase information and to proceed to the next phase in the lifecycle process when the inputted design phase information is satisfied based on a sixth predetermined criteria;
prompting the participant to input integration test plan phase information, wherein the project lifecycle management processor enables to evaluate the inputted integration test plan phase information and to proceed to the next phase in the lifecycle process when the inputted integration test plan phase information is satisfied based on a seventh predetermined criteria;
prompting the participant to input program specification phase information, wherein the project lifecycle management processor enables to evaluate the inputted program specification phase information and to proceed to the next phase in the lifecycle process when the inputted program specification phase information is satisfied based on a eighth predetermined criteria; and
prompting the participant to prepare and input unit test plan phase information, wherein the project lifecycle management processor enables to evaluate the unit test plan creation phase information and to proceed to complete coding of the lifecycle process when the inputted unit test plan creation phase information is satisfied based on a ninth predetermined criteria.

11. The integrated work-flow enabled IT governance system of claim 10, further comprising:
testing the completed code of the lifecycle process upon successful completion of the entry of information relating to each phase in the lifecycle process.

12. The integrated work-flow enabled IT governance system of claim 11, further comprising:
releasing the completed code of the lifecycle process to an end user upon successful completion of the testing.

13. The integrated work-flow enabled IT governance system of claim 12, further comprising:
at least one data storage unit for storing and providing access to data input by the participant via the user interface.

14. The integrated work-flow enabled IT governance system of claim 13, further comprising:
A plurality of software tools for managing and implementing the lifecycle process.

15. The integrated work-flow enabled IT governance system of claim 14, wherein the plurality of software tools includes:
demand management tool;
configuration management tool;
project management tool;
requirements management tool;
dashboards; and
portfolio management tool.

16. The integrated work-flow enabled IT governance system of claim 1, wherein the user-interface is via the Internet using a browser-based, client device.

17. An article comprising:
a storage medium having instructions, that when executed by a computing platform, result in execution of a method for a computer-implemented software lifecycle management tool using an IT governance software, which project is defined by a series of software lifecycle phases, wherein each software development lifecycle phase of the project is evaluated by one or more predetermined external standards, wherein each of the external standards defines a set of quality assurance steps in-order to achieve compliance with the external standard for each phase, comprising:
selecting one of the software development lifecycle phases on a software development lifecycle model user interface;
displaying a screen associated with the selected one of the software development lifecycle phases and capturing information associated with the selected one of the software development lifecycle phases;
inputting the captured information associated with the selected one of the software development lifecycle phases; and
saving the captured information associated with the selected one of the software development lifecycle phases.

18. The article of claim 17, further comprising:
determining whether the selection of all of the software development lifecycle phases is completed;
if so, performing technical reviews by external standards practitioners and field force review personnel;
tailoring the software development lifecycle model by picking and choosing applicable phases and activities in each software development lifecycle software development lifecycle software development lifecycle software development lifecycle software development lifecycle phase based on the project requirements; and
reviewing project manager's dashboard including progress details, review information, rework effort information, and defect metrics.

19. The article of claim 18, further comprising:
if not, repeating selecting, displaying inputting and saving for a next selected one of the software development lifecycle phases.

20. The article of claim 19, further comprising:
if not, producing a candidate syllabic character by the base syllabic character recognizer upon tapping a tapping area located in the writing area and inputting the associated data into the base syllabic character recognizer;
clearing the writing area upon tapping the tapping area; and
displaying the produced candidate syllabic character in the progressive display panel of the syllabic level user interface in the first contrasting color.
